(19) United States
(12) Patent Application Publication
(10) Pub. No.: US 2013/0323503 A1
(43) Pub. Date: Dec. 5, 2013

(54) HYBRID CONDUCTIVE COMPOSITE

(71) Applicants: Denise Radkowski, Medfield, MA (US); John H. Ferguson, Attleboro, MA (US); Robert F. Praino, Westwood, MA (US)

(72) Inventors: Denise Radkowski, Medfield, MA (US); John H. Ferguson, Attleboro, MA (US); Robert F. Praino, Westwood, MA (US)

(73) Assignee: BAYER INTELLECTUAL PROPERTY GMBH, Monheim (DE)

(21) Appl. No.: 13/990,735

(22) PCT Filed: Dec. 5, 2011
(86) PCT No.: PCT/EP11/71764

§ 371 Date: Aug. 13, 2013

(30) Foreign Application Priority Data
Dec. 8, 2010 (US) 12962924

(51) Int. Cl. H01B 1/24; H01B 13/30

(52) U.S. Cl. CPC H01B 1/24; H01B 13/30
USPC 428/336; 428/408; 427/108

(57) ABSTRACT

The present invention provides a hybrid conductive composite made from carbon nanotubes and poly(3,4-ethylenedioxythiophene)/poly(styrene-sulfonate) to reduce the surface resistivity of a transparent thermoplastic substrate. The inventive composites, which may find use in capacitive touch screen displays, require no special treatment or precautions, and are not limited by minimum or maximum component ratios. A wide variation the amounts of carbon nanotube and poly(3,4-ethylenedioxythiophene)/poly(styrene-sulfonate) allows a minimization of the adverse carbon nanotube effects on the composite transparency while producing a stable, low sheet resistance material.

### FIELD OF THE INVENTION

The present invention relates, in general, to conductive materials and more specifically, to a hybrid conductive composite made from carbon nanotubes and poly(3,4-ethylenedioxythiophene)/poly(styrene-sulfonate) applied to a thermoplastic substrate.

### BACKGROUND OF THE INVENTION

WO 2010/032480 discloses a conductive polymer solution which is said to have high storage stability and be capable of forming a conductive coating film having high water resistance. The conductive polymer solution contains a π-conjugated conductive polymer, a polyanion, a compound having an oxetane ring, and a solvent. The conductive polymer solution contains the compound having an oxetane ring in an amount of 1-500% when the total of the π-conjugated conductive polymer and the polyanion is taken as 100%. Coating a mixture of Ag colloidal particles), ethylene glycol, gallic acid, OXBP (oxetane compound), a poly(Na styrenesulfonate)-doped poly(3,4-ethylenedioxythiophene), 2-hydroxyethylacrylamide, aromatic sulfonium salt and ethanol on a PET polyester film and drying was said to give an electrically conductive film with good resistance to water and alcohol.

J. S. Moon, et al., “Transparent conductive film based on carbon nanotubes and PEDOT composites”, Diamond & Related Materials, 14 (2005) 1882-1887, blend acid treated single wall and multi-walled carbon nanotubes with poly(3,4-ethylenedioxythiophene). The authors state they observed a significant decrease in sheet resistance but with a large loss of transparency. The formulations disclosed are limited by the sharp increase in absorbance at carbon nanotube concentrations over 0.03% due to the material incompatibility.

S. Manivannan, et al., “Properties of surface treated transparent conducting single walled carbon nanotube films”, Journal of Materials Science: Materials in Electronics (2010), 21(1), 72-77 disclose transparent conducting single-walled carbon nanotube films fabricated using the spin coating technique. UV-ozone treated and poly(3,4-ethylenedioxythiophene) doped with poly(styrenesulfonate) coated glass substrates together with single-walled carbon nanotubes dispersed in 1,2-dichlorobenzene were used to promote the adhesion of single-walled carbon nanotubes at room temperature. The resultant film had a sheet resistance of 430 Ω/□ for 80% optical transparency at 550 nm. The spin coated single-walled carbon nanotube film after a post fabricated treatment in a mixer of isopropyl alcohol and nitric acid solution had a sheet resistance as low as 120 Ω/□ for 80% optical transparency at 500 nm. The authors state that besides a reduction in sheet resistance, stable and strongly adherent single-walled carbon nanotube films on substrate were obtained which they believe could serve as an alternative to transparent conducting oxides in display and optoelectronic applications.

S. Schwertheim, et al. “PEDOT with carbon nanotubes as a replacement for the transparent conductive coating (ITO) of a heterojunction solar cell” in ]Conference Record of the IEEE Photovoltaic Specialists Conference (2008), 33^{rd}, 1259-1263, report efforts to replace the classical transparent conducting coating, Indium Tin Oxide, (or other TCO's) with a new class of materials, which the authors state are easier to handle and cheaper to mass produce. Possible choices were transparent conductive coatings, which consist of polymers. In the reported investigation, poly(3,4-ethylenedioxythiophene)/poly(styrenesulfonate) was used. Carbon nanotubes were added to render the film electrically conductive. A prerequisite for its use was long-term stability. The degradation of poly(3,4-ethylenedioxythiophene)/poly(styrenesulfonate)/carbon nanotubes as a function of time was determined The transparency, the reflection and the sheet resistance were determined for the virgin samples. After several aging periods, the measurements were repeated. Additional Raman measurements were done to investigate the change in the chemical composition after the aging. No significant changes in transparency, reflection and chemical composition occurred when the samples were subject to aging. The specific resistance was about one to two magnitudes lower for poly(3,4-ethylenedioxythiophene)/poly(styrenesulfonate) layers with carbon nanotubes than for those without carbon nanotubes.

KR 2009-0103250 discloses ink compositions containing (1) nanosized polyethylene dioxythiophene conductive polymer 0.1-2%, (2) nanosized metal particle 0.1-5%, (3) carbon nanotube 0.1-5%, (4) thermosetting or UV radiation hardening crosslinker 3-50%, and (5) one selected from water, isopropanol, methanol, ethanol, acetone, chloroform, chlorobenzene, toluene, anisole, benzene, dichlorobenzene, xylene, or mixture thereof as balance. The transparent electrode manufactured from the ink composition is said to have excellent transparency and conductivity.

JP 2009-211978 discloses a film made from a substrate, a conducting polymer layer, and a carbon nanotube layer. The conducting polymer layer is formed contacting both the substrate and the carbon nanotube layer. Also disclosed is a transparent conductive film having a different structure, i.e. a substrate and a conductive polymer sandwiched in between a pair of carbon nanotube layers, under the substrate contacting the carbon nanotube layer. An optical instrument made of a first substrate having this structure and a second substrate placed under forming a gap is also disclosed.

US Published Patent Application No. 2009/0211819 provides a touch panel containing a first and a second transparent substrate oppositely set, a first signal wire in the first transparent electrode substrate, a first polymer conductive film set in the first transparent electrode substrate, a first non-polymer conductive film on the first polymer conductive film, a second signal wire in the second transparent electrode substrate, a second non-polymer conductive film on the second transparent electrode substrate, and multiple insulation spacers between the first and second substrate. The first transparent electrode substrate and the second transparent electrode substrate are joined by an adhesive, and have a gap. The polymer conductive film and the non-polymer conductive film construct a complex transparent conductive layer. The polymer conductive film is said to provide good flexibility so as to increase the drawing times. The non-polymer conductive film is said to improve the conductivity and reduce surface-contact resistance.

J. Zhu, et al, in “80d Layer-by-layer (LBL) assembled highly conductive, transparent and robust thin carbon nanotube films for optoelectronics”, AIChE Annual Meeting, Conference Proceedings, Philadelphia, Pa., United States, Nov. 16-21, 2008 (2008), 551/1-551/2 report thin conductive transparent films play an important role in many optoelectronic devices. Although indium tin oxide has long been regarded by industry as an appropriate candidate for this application, the authors state it falls short in several aspects. Consequently, two alternative materials, conductive polymers and composites with conductive fillers, were proposed to meet the challenge. More interest was seen in making highly transparent, conductive thin composite electrode using highly conductive fillers, like single walled carbon nanotubes. In line with this, layer-by-layer assembly, well known for its potential to build highly tuned, functional thin films with nanometer-level control of film composition and structure, was proposed to make thin single walled carbon nanotube electrodes with properties equivalent to indium tin oxide.

E. C-W Ou, et al. in “Surface-Modified Nanotube Anodes for High Performance Organic Light-Emitting Diode”, ACS Nano (2009), 3(8), 2258-2264, report high performance organic light-emitting diode devices with transparent and conductive carbon nanotube anodes after modification. The modifications included proprietary poly(3,4-ethylenedioxythiophene)/poly(styrenesulfonate) composite top coating, concentrated HNO₃ acid soaking, and polymer encapsulation. The reported modified nanotube thin film anode achieved a maximum luminescence of approximately 9000 cd/m², close to ITO-based organic light-emitting diode device performance, and an efficiency of approximately 10 cd/A, similar with indium tin oxide -based organic light-emitting diode device. The authors state this performance was approximately 30 to 450 times better than that achieved for organic light-emitting diode devices using carbon nanotube anodes by others. In addition, the mechanical property, work function, sheet resistance, and surface morphology of modified carbon nanotube thin-film anodes was investigated.

J-W Huh, et al., in “Carbon nanotube and conducting polymer dual-layered films fabricated by microcontact printing”, Applied Physics Letters (2009), 94(22), 223311-1to 223311-3 report carbon nanotube/conducting polymer dual-layered film electrodes fabricated by microcontact printing for flexible transparent electrodes of organic thin film transistors. The conducting polymer dual-layered film electrodes showed approximately 1000 Ω/□ surface resistivity and approximately 93% transmittance at an extremely low loading of single-walled carbon nanotubes, and could be self-aligned with a precision of 20 μm. The conducting polymer dual-layered film electrodes were applied as the source and drain electrodes in organic thin film transistors without any supplementary alignment process, which led to a mobility and a current on/off ratio of approx. 0.02 cm² V⁻¹ s⁻¹ and approximately 10⁴, respectively.

JP 2009-035619 provides compounds made from (A) electrical conducting polymers, (B) ionic liquids, and carbon nanotubes with abundance of primary particles ≧80%. The carbon nanotubes may be surface-treated with organic compounds. The films, obtained by applying the compounds on substrates, contain 30-50 wt. % carbon nanotubes. The films are said to be useful for transparent electrodes in displays, solar cells, and touch panels and coatings of substrates in electromagnetic shields. The films are also said to show high transparency and low unevenness in electrical conductivity.

E.-H. Ha, et al., in “Preparation and characterization of carbon nanotube/conducting polymer nanocomposites”, Cailiao Gongcheng (2008), (10), 122-125 report the manufacture of transparent conductive coating with what is said to be excellent transparence and conductivity by introducing self-assembling carbon nanotubes into an integrated conductive network in resin media. The combination of carbon nanotubes with polymers is said to offer an attractive route to introduce new electronic properties based on morphology modification or electronic interaction between the two components. Carbon nanotube/poly(3,4-ethylenedioxythiophene) nanocomposites and carbon nanotube/polyaniline nanocomposites were prepared by in situ potentiostatic deposition of poly(3,4-ethylenedioxythiophene) or polyaniline onto carbon nanotubes and characterized with TEM, FTIR and standard four-probe method.

US Published Patent Application No. 2007/0246689 provides optically transparent, conductive polymer compositions and methods for making them. These conductive polymer compositions contain an oxidized 3,4-ethylenedioxythipene polymer, a polysulfonated styrene polymer, single wall carbon nanotubes and/or metallic nanoparticles. The conductive polymer compositions can include both single wall carbon nanotubes and metallic nanoparticles. The conductive polymer compositions have a sheet resistance of less than about 200 Ω/□, a conductivity of greater than about 300 siemens/cm, and a visible light (380-800 nm) transmission level of greater than about 50%, preferably greater than about 85% and most preferably greater than about 90% (when corrected for substrate). The conductive polymer compositions containing single wall carbon nanotubes are made by mixing the oxidized 3,4-ethylenedioxythiopene polymer and polysulfonated styrene polymer with single wall carbon nanotubes and then sonicating the mixture. The conductive polymer compositions containing metallic nanoparticles are made by a process of in situ chemical reduction of metal precursor salts.

R. Jackson, et al. in “Stability of doped transparent carbon nanotube electrodes”, Advanced Functional Materials (2008), 18(17), 2548-2554, evaluated the effectiveness of p-doping transparent single-walled carbon nanotube films via chemical treatment with HNO₃ and SOCl₂. Stability of the improvement in electrical conductivity after doping was investigated for different doping treatments as a function of exposure time to air and as a function of temperature. Doped films were found to have a greater than twofold increase in conductivity with sheet resistance values as low as 105 Ω/□ with an optical transmittance of 80% at 550 nm. However, doping enhancements demonstrated limited stability in air and under thermal loading. The application of a thin capping layer of poly(3,4-ethylenedioxythiophene)/poly(styrenesulfonate) was shown to stabilize the improvements in conductivity, evidenced by sustained lower sheet resistance in both air and under thermal loading.

G-F Wang, et al., in “Highly conductive flexible transparent polymeric anode and its application in OLEDs” IEEE Electronic Components and Technology Conference (2007), 57th(Vol. 4), 1536-1539 detail a highly conductive flexible transparent polymeric anode fabricated by inclusion of single-wall carbon nanotubes into an aqueous poly(3,4-ethylene dioxythiophene: poly(styrene sulfonate) system. The transmittance and conductivity of the anode was studied as a function of the single-wall carbon nanotube loading. Flexible transparent anodes with low sheet resistance were fabricated and organic light-emitting devices fabricated using poly(3,4-ethylene dioxythiophene: poly(styrene sulfonate)/single-wall carbon nanotube as the anode exhibited a close performance to that obtained using indium tin oxide anode.

K. Ryu, et al., in “Transparent, conductive and flexible carbon nanotube films and their application in organic light emitting diodes” Materials Research Society Symposium Proceedings (2006), vol. 936 (No pp. given,) Paper #: 0936-L04-04, report a transfer printing technique to directly transfer vacuum-filtered nanotube film to glass and plastic substrates. A typical single-wall carbon nanotube-film had a transparency of approximately 80% and a sheet resistance around 400 Ω/□. Further improvement to the nanotube film included SOCl₂ doping and poly(3,4-ethylene dioxythiophene) passivation, which was said to have significantly improved the sheet conductance and surface quality of the nanotube films. The optimized single-wall carbon nanotube films were applied as whole injection electrodes to demonstrate organic light emitting diodes on both rigid glass and flexible substrates.

U.S. Pat. No. 7,645,497, issued to Spath et al., provides an electronically conductive article containing at least one conductive carbon nanotube layer in contact with at least one conductive layer containing an electronically conductive polymer.

D. Zhang, et al., in “Transparent, Conductive, and Flexible Carbon Nanotube Films and Their Application in Organic Light-Emitting Diodes”, Nano Letters (2006), 6(9), 1880-1886 report comparative studies on transparent conductive thin films made with two kinds of com. carbon nanotubes: HiPCO and arc-discharge nanotubes. The films were further exploited as hole-injection electrodes for organic light-emitting diodes on both rigid glass and flexible substrates. Zhang, et al.'s experiments are said to reveal that films based on arc-discharge nanotubes are overwhelmingly better than HiPCO-nanotube-based films in all of the critical aspects, including surface roughness, sheet resistance, and transparency. Further improvement in arc-discharge nanotube films was said to have been achieved by using poly(3,4-ethylene dioxythiophene) passivation for better surface smoothness and using SOCl₂ doping for lower sheet resistance. The optimized films showed a typical sheet resistance of approximately 160 Ω/□ at 87% transparency and were used successfully to make organic light emitting diodes with high stabilities and long lifetimes.

D. Carroll, et al., in “Polymer-nanotube composites for transparent, conducting thin films”, Synthetic Metals (2005), 155(3), 694-697, detail highly conductive, highly transparent thin films fabricated from polymer-single walled carbon nanotube blends. Using poly(3,4-ethylenedioxythiophene) doped with poly(styrene sulfonate) as a host material, an excellent dispersion of single wall nanotubes was said to be achieved enhancing the conductivity with relatively low loadings <3 wt %. Raman spectroscopy indicated there was little bundling of the single wall nanotubes in the matrix and that the nanotubes were sensitive to residual stress within the film. As the host bulk conductivity was increased, enhancements of the overall composite conductivity were observed to be proportional. The authors state these results suggested that the energy barrier to nanotube-nanotube carrier hopping within the matrix can be modified in accordance with a heterogeneous conduction model.

A need continues to exist in the art for conductive materials which can reduce the surface resistivity of plastic films for use in such applications as capacitive touch screen displays.

### SUMMARY OF THE INVENTION

Accordingly, the present invention provides a hybrid conductive composite made from carbon nanotubes and poly(3,4-ethylenedioxythiophene)/poly(styrene-sulfonate) to reduce the surface resistivity of a transparent thermoplastic substrate. The inventive composites, which may find use in capacitive touch screen displays, require no special treatment or precautions, and are not limited by minimum or maximum component ratios. A wide variation the amounts of carbon nanotube and poly(3,4-ethylenedioxythiophene)/ poly(styrene-sulfonate) allows a minimization of the adverse carbon nanotube effects on the composite transparency while producing a stable, low sheet resistance material.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention provides a coating containing a lower layer containing carbon nanotubes and an upper layer containing poly(3,4-ethylenedioxythiophene)/poly(styrene-sulfonate).

The present invention further provides a hybrid conductive composite containing a coating having a lower layer containing carbon nanotubes, an upper layer containing poly(3,4-ethylenedioxythiophene)/poly(styrene-sulfonate), and a transparent thermoplastic substrate, wherein the upper and lower layers are applied to the thermoplastic substrate.

The present invention still further provides a method of reducing surface resistivity of a transparent thermoplastic substrate involving, applying a coating having a lower layer containing carbon nanotubes and an upper layer containing poly(3,4-ethylenedioxythiophene)/poly(styrene-sulfonate) to the substrate and curing the coating.

Carbon nanotubes may be classified into single-walled carbon nanotubes which are rolled graphene sheets, and multi-walled carbon nanotubes, which are nested cylindrical carbon nanotubes with different diameters. Either type of nanotube may be useful in the present invention. For fluids, a coatable dispersion, spray formulation, or other thin carbon nanotube coating fluids dispersed in a variety of ways in various solvent systems are acceptable as carbon nanotube layers. The present inventors contemplate such layers can be applied to a substrate in a variety of ways, including, but not limited to, uniform coating, printing, spray, ink jet, etc.

The present inventors believe with the proper coating layer, any of the following thermoplastics would be suitable as the substrate: acrylonitrile-butadiene-styrene, poly(methyl methacrylate), cyclic olefin copolymer, ethylene-vinyl acetate, ethylene vinyl alcohol, polytetrafluoroethylene, fluorinated ethylene propylene, perfluoroalkoxy polymer resin, ethylene tetrafluoroethylene, liquid crystal polymer, polyacrylates, polyethylene terephthalate, polycarbonate, polyester, polyethylene, polyetheretherketone, polyetherketoneketone, polyetherimide, polyethersulfone, polysulfone, polylactic acid, polymethyl-pentene, polypropylene, polystyrene, polysulfone, thermoplastic polyurethane, polyvinyl chloride, polyvinylidene chloride, and styrene-acrylonitrile. Polycarbonate and polyethylene terephthalate are preferred in the context of the present invention, with polycarbonate particularly preferred. Glass may also be suitable as a substrate.

Although not a requirement of the thermoplastic substrate, the substrate is exemplified in this description by a flexible film. Substrate properties require the substrate be able to withstand drying of the poly(3,4-ethylenedioxythiophene) layer at approximately 110° C. without deformation during the drying process. This requirement may influence the thickness limit, for example: high temperature substrates may be thinner than lower temperature substrates as long as deformation is prevented. For polycarbonate used in the examples, a film of preferably from 125 μm to 175 μm was found to be a suitable thickness.

The inventive hybrid composite with carbon nanotubes as the lower layer and poly(3,4-ethylenedioxythiophene)/poly(styrene-sulfonate) as the upper layer applied to a flexible thermoplastic substrate (polycarbonate film) produces a high transmission; low resistivity film which has been demonstrated to be stable. The resistivity of the composite of the present invention was measured to be 260 Ω/□ with a percent visual transmission of 89%. The inventive composite exhibited consistent resistivity with relative humidity fluctuations. By contrast, the present inventors are aware of several instances in which a material made of poly(3,4-ethylenedioxythiophene)/poly(styrene-sulfonate) only on polycarbonate failed to be conductive. Also, a material containing only commercially available carbon nanotubes provided consistent but high resistivity values. The inventive composite provides consistent, measureable conductance.

### EXAMPLES

The present invention is further illustrated, but is not to be limited, by the following examples. All quantities given in “parts” and “percents” are understood to be by weight, unless otherwise indicated.

One embodiment of the inventive composite is represented by the diagram below.

Poly(3,4-ethylenedioxythiophene)/poly(styrene-sulfonate) layer
300 nm (dry basis)
Carbon nanotube layer
8 nm (dry basis)
Polycarbonate transparent substrate
125 μm

This composite was created in accordance with the following procedure:

### CNT Coating Solution Preparation

Carbon nanotubes (SG-76 from SouthWest NanoTechnologies) at a concentration of 0.001% were dispersed using a 1% TRITON X-100 solution in water. The solution was adjusted to pH 11.0 with ammonium hydroxide and sonified for 40 minutes. Following sonification, the solution was centrifuged at 4000 rcf for 30 minutes. The liquor was decanted from the precipitate.

### Coating Process

To promote adhesion, the substrate was corona treated. Then, the carbon nanotube coating solution was applied to the substrate using a 6 micron wire-wound coating rod, a Meyer rod. The film was cured prior to surfactant removal by means of forced hot air. The surfactant was removed from the coating using 20% isopropanol rinse water. After rinsing, the film was dried at 100° C. for 10 minutes to remove residual moisture and to further promote adhesion to the substrate. In this example, the dried carbon nanotube coating had a thickness of 8 nm, however the thickness of the carbon nanotube layer may vary from 8 nm to 27 nm.

Poly(3,4-ethylenedioxythiophene)/poly(styrene-sulfonate) aqueous solution product (CLEVIOS F EE PE FL, from H. C. Starck) was coated over the carbon nanotubes with a 20 micron Meyer rod to create a 300 nanometer dry film thickness, but the poly(3,4-ethylenedioxythiophene)/poly(styrene-sulfonate) layer thickness may vary between 60 nm and 1000 nm. Following coating, the film was cured in an oven at 100° C. for 30 minutes to remove volatile coating additives and to cure the film.

### Measurement

The films were equilibrated to the environment prior to measuring the optical density and the resistivity. Environmental conditions varied between 20° C.-22° C. and 43% relative humidity—76% relative humidity. Percent transmission was measured using an X-RITE 310 photographic densitometer. Resistivity of the coated film was measured using a Jandel Model HM20 4-point probe resistivity test fixture. To characterize their stability and consistency, the films were monitored over several weeks.

### Performance

As was seen in several of the papers mentioned in the Background of the Invention section, carbon nanotubes and poly(3,4-ethylenedioxythiophene) appear to be additive with each other, so the ability to independently optimize the performance of the two materials is advantageous. Maximizing the transparency of the carbon nanotube layer while stabilizing the inherently low absorbance, but higher conductivity of the poly(3,4-ethylenedioxythiophene) layer, has been demonstrated. The inventive material also appears to perform better in conditions known to degrade performance of the individual components, such as exposure high humidity environments.

A poly(3,4-ethylenedioxythiophene)/poly(styrene-sulfonate) only film is capable of delivering low resistivity values at high percent transmission values. However, these films display large measurement variability; as great as 1000%. At times, resistivity for a poly(3,4-ethylenedioxythiophene)/ poly(styrene-sulfonate) only films was undetected.

The carbon nanotube only film using commercially available materials cannot deliver low resistivity at high percent transmission, but such a film has been demonstrated to be stable over a wide range of environmental conditions.

In contrast to the single material films, the inventive composite yields low resistivity; <300 Ω/□ with high percent transmission, ≦89%. In addition, the composite of the present invention delivers consistent electrical performance with changing environmental conditions.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

1. A coating comprising:
a lower layer comprising carbon nanotubes and
an upper layer comprising poly(3,4-ethylenedioxythiophene)/poly(styrene-sulfonate).

2. The coating according to claim 1, wherein said lower layer comprises a thickness of from about 8 nm to about 27 nm.

3. The coating according to claim 1, wherein said upper layer comprises a thickness of from about 60 nm to about 1000 nm.

4. The coating according to claim 1, wherein said nanotubes are single walled.

5. The coating according to claim 1, wherein said nanotubes are multi-walled.

6. A hybrid conductive composite comprising:
a coating comprising,
a lower layer comprising carbon nanotubes and
an upper layer comprising poly(3,4-ethylenedioxythiophene)/poly(styrene-sulfonate), and
a transparent thermoplastic substrate,
wherein said upper and said lower layers of said coating are applied to the substrate.

7. The composite according to claim 6, wherein said lower layer of the coating comprises a thickness of from about 8 nm to about 27 nm.

8. The composite according to claim 6, wherein said upper layer of the coating comprises a thickness of from about 60 nm to about 1000 nm.

9. The composite according to claim 6, wherein said thermoplastic substrate is at least one selected from the group consisting of acrylonitrile-butadiene-styrene, poly(methyl methacrylate), cyclic olefin copolymer, ethylene-vinyl acetate, ethylene vinyl alcohol, polytetrafluoroethylene, fluorinated ethylene propylene, perfluoroalkoxy polymer resin, ethylene tetrafluoroethylene, liquid crystal polymer, polyacrylates, polyethylene terephthalate, polycarbonate, polyester, polyethylene, polyetheretherketone, polyetherketoneketone, polyetherimide, polyethersulfone, polysulfone, polylactic acid, polymethylpentene, polypropylene, polystyrene, polysulfone, thermoplastic polyurethane, polyvinyl chloride, polyvinylidene chloride, styrene-acrylonitrile and glass.

10. The composite according to claim 6, wherein said thermoplastic substrate comprises polycarbonate.

11. The composite according to claim 6, wherein said thermoplastic substrate comprises a thickness of from about 125 μm to about 175 μm.

12. The composite according to claim 6, wherein said thermoplastic substrate is flexible.

13. The composite according to claim 6, wherein said thermoplastic substrate comprises a film.

14. The composite according to claim 6, wherein said nanotubes are single walled.

15. The composite according to claim 6, wherein said nanotubes are multi-walled.

16. A method of reducing surface resistivity of a transparent thermoplastic substrate comprising:
applying a coating comprising a lower layer comprising carbon nanotubes and an upper layer comprising poly(3,4-ethylenedioxythiophene)/poly(styrene-sulfonate) to the substrate; and
curing said coating.

17. The method according to claim 16, wherein said lower layer comprises a thickness of from about 8 nm to about 27 nm.

18. The method according to claim 16, wherein said upper layer comprises a thickness of from about 60 nm to about 1000 nm.

19. The method according to claim 16, wherein said nanotubes are single walled.

20. The method according to claim 16, wherein said nanotubes are multi-walled.

21. The method according to claim 16, wherein said thermoplastic substrate is at least one selected from the group consisting of acrylonitrile-butadiene-styrene, poly(methyl methacrylate), cyclic olefin copolymer, ethylene-vinyl acetate, ethylene vinyl alcohol, polytetrafluoroethylene, fluorinated ethylene propylene, perfluoroalkoxy polymer resin, ethylene tetrafluoroethylene, liquid crystal polymer, polyacrylates, polyethylene terephthalate, polycarbonate, polyester, polyethylene, polyetheretherketone, polyetherketoneketone, polyetherimide, polyethersulfone, polysulfone, polylactic acid, polymethylpentene, polypropylene, polystyrene, polysulfone, thermoplastic polyurethane, polyvinyl chloride, polyvinylidene chloride, styrene-acrylonitrile and glass.

22. The method according to claim 16, wherein said thermoplastic substrate comprises polycarbonate.

23. The method according to claim 16, wherein the thermoplastic substrate comprises a thickness of between from about 125 μm to about 175 μm.

24. The method according to claim 16, wherein said thermoplastic substrate is flexible.

25. The method according to claim 16, wherein said thermoplastic substrate comprises a film.
